(19) United States
(12) Patent Application Publication
(10) Pub. No.: US 2017/0110898 A1
(43) Pub. Date: Apr. 20, 2017

(54) KEY RING ATTACHABLE RECHARGEABLE MOBILE PHONE POWER AND CONTROL DEVICE

(71) Applicant: GO DEVICES LIMITED, Kowloon (HK)

(72) Inventors: Polydoros Kyriakoulis, San Francisco, CA (US); Aristotelis Barakos, Athens (GR); Mark Brinkerhoff, San Jose, CA (US); Eric Aldenbrook, Cupertino, CA (US); Thomas Geraty, San Jose, CA (US); George William Melcer, Oakland, CA (US); Walter Maclay, Sunnyvale, CA (US); Stuart Tyrrell, Los Altos, CA (US); Ying Hong Zheng, Kowloon (HK); Ji Lei Guan, Kowloon (HK)

(21) Appl. No.: 15/311,915

(22) PCT Filed: Sep. 10, 2015
(86) PCT No.: PCT/CN2015/089388

§ 371 Date: Nov. 17, 2016

Related U.S. Application Data
(63) Continuation-in-part of application No. 14/484,040, filed on Sep. 11, 2014, now abandoned.

(51) Int. Cl. H02J 7/00

(52) U.S. Cl. CPC H02J 7/0042; H02J 7/0047; H02J 7/0054; H02J 2007/0062; H02J 2007/0059

(57) ABSTRACT

A portable power source and control device for a mobile phone or tablet is releasably attachable to a user's key ring or key chain and sized to be carried in a pocket or purse. The device has an internal rechargeable battery to provide emergency power for operating the user's phone, USB connectors for connection a power source and the phone, an internal microcontroller, and a Bluetooth® wireless communicator. A user actuator generated a locator command causes the phone to ring to indicate its location; and a locator command from the phone causes the device to emit a sound to indicate the device's location. The device can determine and indicate via LEDs the charge level of the battery, and has flash memory for data storage and transfer between devices.

### BACKGROUND

This invention relates generally to portable battery power devices for mobile devices, and more particularly to a portable multi-functional device for back-up power and recharging the internal battery of a mobile phone or other similar electronic device, for remotely controlling the mobile phone, and for communicating with the mobile phone for locator, data synchronization and other operations.

Today, most people carry and rely upon mobile telephones or other similar electronic devices for communications and information while they are on the go, and to many mobile phones have become as essential as their keys. While mobile phones are convenient and for many are a necessity, they operate on an internal battery that must be recharged frequently. This is particularly true of the so-called “mobile phones” which are essentially small portable computers that drain their internal battery quickly. When the battery runs out, the phone cannot be used until the battery is recharged. Phone chargers and spare batteries are bulky and inconvenient to carry, and many people either forget them or simply do not carry them. When the battery is drained, which typically occurs when the phone is most needed, finding some place to recharge it is often a problem.

Another problem with mobile phones is that they are often misplaced. While one may dial the telephone number of the phone to ring the phone to locate it, this requires access to another telephone in the vicinity of where the phone was misplaced in order to hear the phone ring. Sometimes, there is not another available telephone in the vicinity. There is a related problem with respect to keys which also are frequently misplaced. Keys, however, do not have ringers, and are therefore more difficult to locate.

It is desirable to provide devices and methods to address the foregoing and other problems and inconveniences associated with mobile phones, and it is to these ends that the present invention is directed.

### SUMMARY OF THE INVENTION

The invention addresses the foregoing and other problems by providing, in one aspect, a portable power and control device containing a rechargeable battery that can be conveniently carried and connected to a mobile phone when the internal phone battery runs out to recharge the phone battery and provide an emergency supply of power to keep the phone operating for a period of time until its internal battery can be fully recharged. In a preferred form, the portable device is attachable to a key ring or keychain so it may be carried with the keys of the phone user, and it may include a USB or other connector that enables the device to be connected to a computer or USB power source to recharge its internal battery. The device may also have a user activated indicator that shows the level of charge of its rechargeable battery to inform the user when the device battery requires recharging. In another aspect, the power and control device is preferably provided with an internal microcontroller and other circuitry so that it may interface either wirelessly via Bluetooth® or directly via a cable with a cooperating mobile phone application (“app”) to perform a number of different functions. These functions may include a locator function that permits the device to activate the phone ringer or other audible emitter on the phone so that a misplaced phone may be located. The phone app may likewise include a locator function that identifies the previous location of the keys, as by using GPS, so that misplaced keys may be located.

Preferably, the Bluetooth® module is useable to receive a transmission from a mobile phone commanding the device to switch ON or OFF a Wi-Fi module in the device. Furthermore, the Bluetooth® module is useable to command the portable mobile phone power and control device to communicate with a Cloud system.

In this case, it is preferable that the Bluetooth® module is useable to transmit to the device a user identity and password to for establishing communication between the portable mobile phone power and control device with a Cloud system.

In further aspects, the power and control device may cooperate with the phone app to remotely control phone functions, such as the phone ringer or its camera, or to remotely control external devices such as music players and the like via the phone app. The device may additionally contain flash memory for data storage, transfer and synchronization with the phone or a computer, and may enable encrypting the data in the flash memory so that the data is secure.

In further aspects, the device contains at least one suitable antenna for wireless communication with a computer, or any similar computing device including cloud systems, mobile phones or tablets. This provides the possibility that the device does not require physical connectors for communicating with the computer.

In yet further aspects, the device contains a battery which may be recharged by induction. This provides the possibility that certain embodiments of the device may be relieved of physical connectors for re-charging the battery in the device. Preferably, the induction method used is resonant induction. Resonant induction allows the device to be recharged at a short distance from the charging station, which relieves the burden of orienting the device to the charging station in a specific way in order to allow induction coupling between a coil in the device and a coil in the charging station.

In yet further aspects, the device is able to recharge a mobile phone by induction. An inductive coil is provided in the device for coupling with an inductive coil connected to a mobile phone. A current flowing in the device can be picked up by the coil in the mobile phone for power transfer from the device to the mobile phone.

Accordingly, the invention proposes a portable mobile phone power device comprising: a housing having a rechargeable battery therein, the housing comprising a first wire coil for receiving power by induction for recharging the rechargeable battery; the housing comprising a second wire coil for transmitting power by induction for recharging a mobile phone.

Accordingly, the device may be relieved of having physical connectors for both charging itself up or for charging up a mobile phone, thereby reducing wear and tear and prolonging the lifespan of the device.

Although it is mentioned that a mobile phone may be charged up using the portable mobile phone power device, it is envisaged that other devices can be charged up wirelessly using the portable mobile phone power device, for example water heating mugs, PDAs, and so on.

Preferably, the device further comprises a memory for data storage; and a Wi-Fi transceiver for transmitting to and receiving data from a host device wirelessly. This allows the device to provide extra or external memory for a computer or computing device. Therefore, the device is also a portable memory. As the data transfer can be done by Wi-Fi, there is no need for a wire connector to connect to the host. Preferably, the device is also configured as a key ring, and a suitable inductive charging station is provided for charging up the device as well as provided as a key holder. The user can simply dump his keys attached to the device as a key ring into the key holder, and the device will be charged up by induction. The user does not need to actively remember to charge up the portable mobile phone power device.

Preferably, the Wi-Fi transceiver in the device is useable to receive data from a computer, and to re-transmit the data to a pre-determined cloud system for storage. The cloud system is automatically in connection whenever the device is within the vicinity of a Wi-Fi access point. This provides a portable portal for cloud connection for any computer in communication with the device. An advantage of this is that the user is protected from data loss in the event he lost the device, as all data is automatically forwarded from the computer to the cloud system. Conversely, the device is able to retrieve data from the cloud system and re-transmit the data to the computer.

Preferably, the device further comprises a Bluetooth® module; wherein the Bluetooth® module is configured to receive a transmission from a mobile phone commanding the device to switch ON or wake up its Wi-Fi transceiver. This allows energy savings to let the WiFi module within the device to be asleep or be switched OFF until activated or switched ON. More preferably, the Bluetooth® module is useable to receive from a computer a username and password for establishing communication between the portable mobile phone power and control device and the host device. This relieves the need for human-intervention to establish the WiFi connection, such as removing the need for entering the username and password into the host for establishing communication with the portable mobile phone power device.

### BRIEF DESCRIPTION OF THE DRAWINGS

FIG. 1 is a perspective view of a preferred embodiment of a mobile phone power and control device in accordance with the invention that is releasably attachable to a key ring or keychain, the device being shown connected to a mobile mobile phone;

FIG. 2 comprising FIGS. 2A-C are, respectively, a top view, a left side view, and a cut-away top view of the device of FIG. 1;

FIG. 3 is an electrical block diagram of a preferred embodiment of the internal electronics of the device of FIGS. 1 and 2;

FIG. 4 is a functional block diagram illustrating the device and the phone app interfaces for performing commands;

FIG. 5 illustrates the interconnections between the microprocessor and a battery charger of FIG. 3;

FIG. 6 illustrates the operations of the device microprocessor for controlling the device power regulators;

FIG. 7 is a functional block diagram illustrating a process for my device to detect and indicate the charge on the device battery;

FIG. 8 is a functional block diagram illustrating operations performed by the device microprocessor in response to phone commands; and

FIG. 9 is a functional block diagram illustrating the operation of the phone app to send commands the mobile device;

FIG. 10 is a view of another preferred embodiment to that of FIG. 1;

FIG. 10a is a view of a charging station useable with the embodiment of FIG. 10;

FIG. 11 is yet another embodiment to that of FIG. 1 in the plan view;

FIG. 12 is a cross-section of the embodiment of FIG. 11;

FIG. 13 is FIG. 11 in the front view;

FIG. 14 is FIG. 11 in the back view;

FIG. 15 is FIG. 11 in the back view but flipped over from that in FIG. 14;

FIG. 16 shows a variation of the embodiment of FIG. 11;

FIG. 17 is a schematic flowchart showing usage of one of the embodiments; and

FIG. 18 (presented as split drawings 18a and 18b) is a flowchart of one of the embodiments showing how the device 100 interacts with a cloud system.

### DESCRIPTION OF PREFERRED EMBODIMENTS

The power and control device of the invention is particularly well adapted for use with mobile electronic devices such as smart mobile phones, tablets and the like, and will be described in that context. It will be appreciated, however, that this is illustrative of only one utility of the invention, and that a power and control device in accordance with the invention has other applicability more generally in connection with other types of portable electronic devices. As used herein, the term “mobile phone” will be used to refer not only to mobile telephones, but also to other portable electronic and computing devices such as tablets.

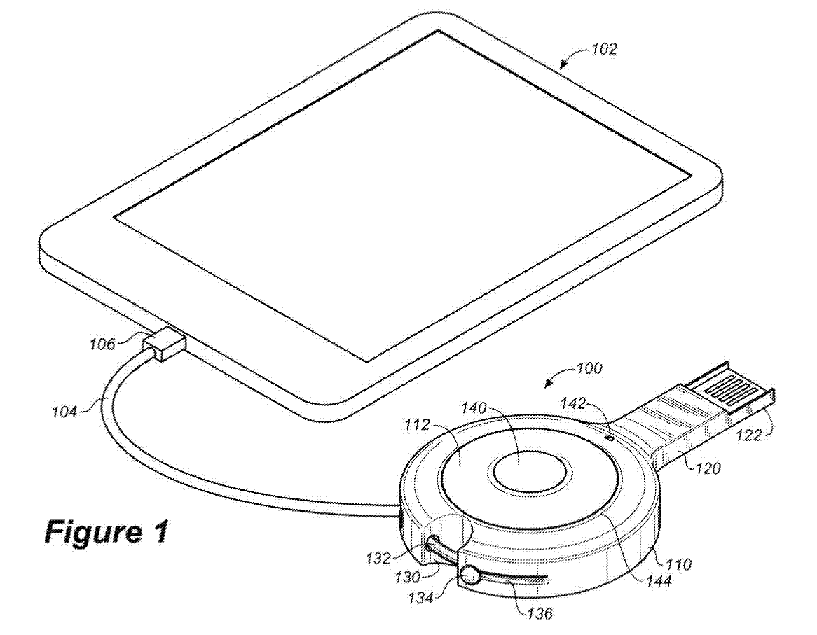

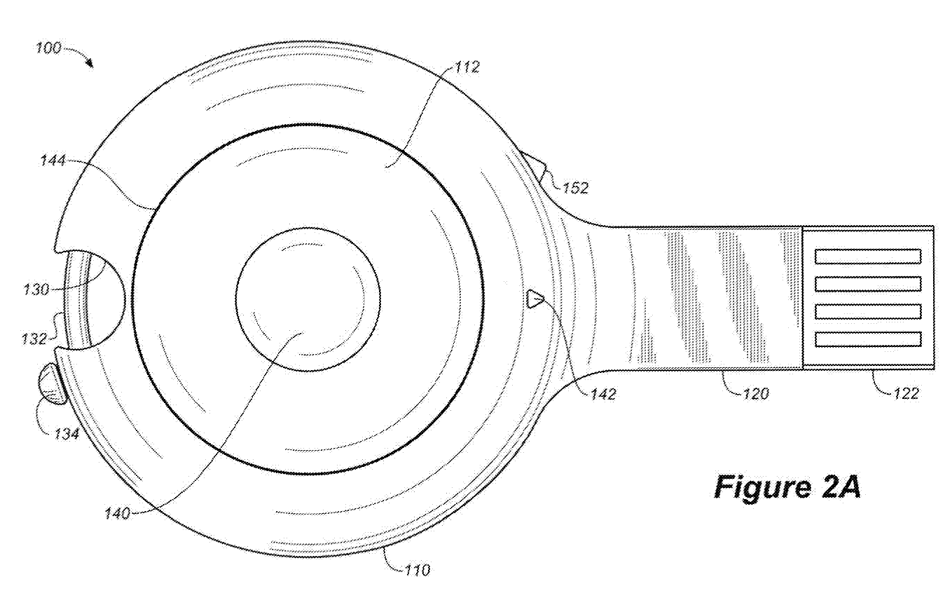

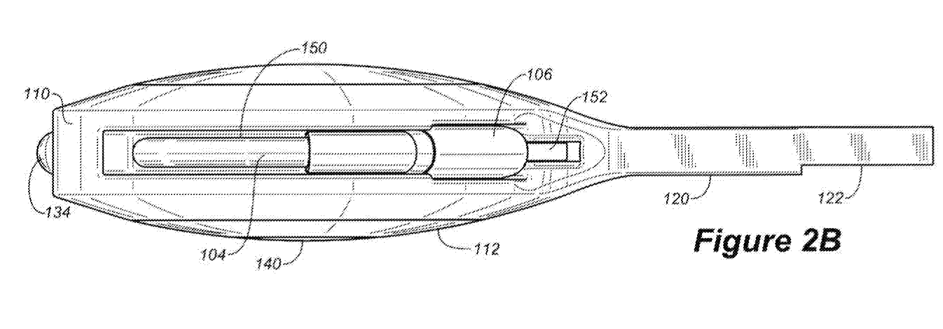

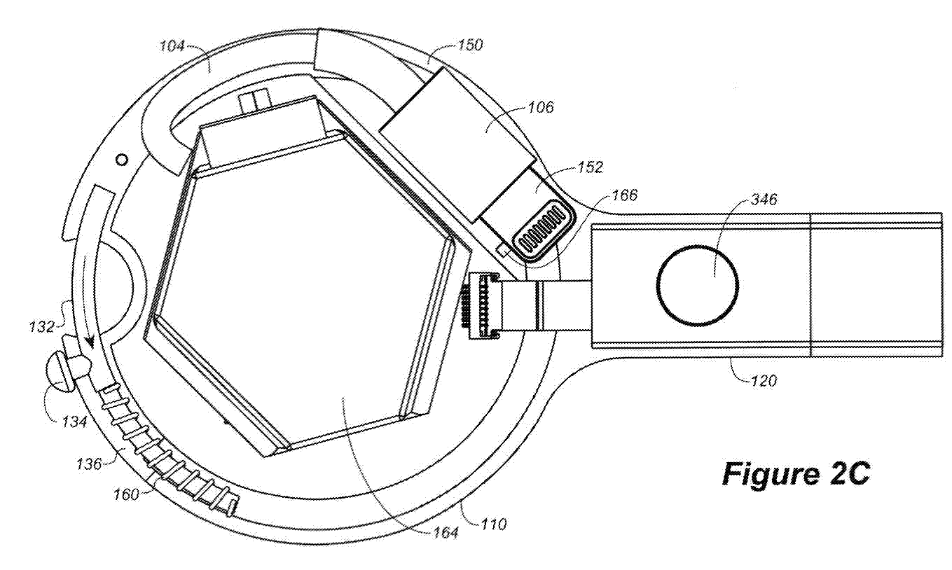

FIG. 1 is a perspective view illustrating a power and control device 100 in accordance with a preferred embodiment of the invention connected to a mobile phone 102 by a cable 104 having a connector 106 adapted to interface with the mobile phone 102. Cable 104 and connector 106 may comprise an electrical bus for transferring operating power to the phone and transferring data between the device and the phone, as will be described. FIG. 2A is a top plan view of the power and control device 100, FIG. 2B is a left side view of the device, and FIG. 2C is a cut away top view of the device 100 with the top cover removed to show portions of the interior of the device housing. The device 100 may comprise a short generally cylindrical housing 110 having a convex or dome-shaped upper surface 112 and a similarly shaped lower surface 114 imparting to the housing a generally double dome-shaped configuration that is mirrored about a horizontal plane through the center of the cylindrical housing, as best shown in FIG. 2B. Projecting laterally outwardly from one side of the cylindrical housing is a generally rectangular projection 120 that includes a USB connector 122 at its outer end. As will be described in more detail shortly, the USB connector is adapted to interface with a computer or the like for receiving power from the computer or a power source to charge a rechargeable backup battery within the housing and for communicating data between the computer and electrical circuitry within the device. As will also be described in more detail, the device 100 may supply (via the cable 104 extending from the left side of the housing that connects via connector 106 to the mobile phone 102) battery power from the backup battery within the device housing to power and recharge a drained internal battery of the mobile phone so the phone can continue operating for a period of time until its battery can be recharged. As will be further described below, the power and control device 100 may additionally communicate bidirectional data and control signals wirelessly and via cable 104 between the mobile phone and the electronics within the device housing. The control signals enable control of operations within the device by the mobile phone and control of operations of the phone by the device. The control signals also enable the device to remotely control other external devices, such as music players, etc., via the mobile phone app.

As further illustrated in FIGS. 1 and 2A, housing 110 may have a semi-spherically shaped cavity 130 with a user controllable releasable latching mechanism comprising a curved (to match the curvature of the housing) slideable latch 132 controlled by a knob 134 extending across the cavity 130. Latch 132 may slide within a slot 136 within the housing 110 to open and provide access to the cavity for receiving a key ring, keychain or the like, and may be spring loaded by a spring 160 in the slot to bias the latch to a closed position, as shown in FIG. 2C. Upon being closed, the sliding latch may capture and retain the user's key ring within the cavity to connect and attach the power and control device to the key ring. Since most people including mobile phone users almost always carry keys, the embodiment enables mobile phone users to conveniently carry a backup battery power source with their keys to provide power for their mobile phone when the phone battery goes dead. The top of the dome-shaped housing may have a centrally located user actuated pushbutton 140 and a small triangularly shaped multicolor LED 142, for purposes to be described. There may also be a ring of LEDs 144 located in the domed top 112 of the housing. Cable 104 and connector 106 may be contained within a circumferentially extending slot 150 formed in one side of the housing 110, as best shown in FIGS. 2B-2C, when they are not connected to the phone 102. There may be a small magnet 166 within the slot 150 adjacent to the location of the metal tip 152 of connector 106, as shown in FIG. 2C, to retain the connector and cable within the slot when not in use. The interior of the housing has space 164 to accommodate the internal battery and associated electronics, as will be described.

The power and control device 100 may have any convenient size, shape and dimensions. Preferably, it is small enough to conveniently and comfortably fit within a user's pocket or purse attached to the user's key ring. Aesthetically, in a preferred embodiment the device has certain proportions. The ratio of the diameter of the ring 144 in the top surface to the diameter of the cavity 130 is preferably of the order of 11:3. The cavity 130 is preferably semi-spherically shaped. If the sides of the triangularly shaped LED 142 were extended, they would preferably meet the diameter of the ring 144. The distance between the center of the latch member 132 and the top of the triangular LED 142 is preferably equal to the sum of the diameters of the cavity 130 and the ring 144, and the overall length of the device from the latch to the USB connector is preferably 1.414 times the diameter of ring 144. Other proportions as well as other configurations may, of course, be used.

In order to serve as an emergency source of power for a mobile phone, a power and control device in accordance with the embodiment has an internal rechargeable battery that may be recharged by connecting the device to the USB port of a computer or to a USB power adapter. As will be described, the device may also have internal electronic circuitry to control the recharging of the internal battery (as well as for performing other operations, which will also be described), and enable the state of the internal battery charge to be determined and indicated to a user by multicolor LEDs 142 so that the user may recharge the battery as needed. When emergency backup power is required to power a mobile phone whose battery that has been drained, the phone can be connected to the device using cable 104 and connector 106 to power the phone and recharge the battery from the internal battery of the device. For use with Android and Windows phones and tablets, connector 106 may be a mini USB connector. For use with Apple phones and tablets, connector 106 may be a Lightning connector. Because the device is formed to be releasably attached to the user's key ring and carried with the user's keys, the user will always have backup phone power available when it is needed.

In addition to providing backup power, the device may also cooperate with the mobile phone to perform other functions and operations. One of these functions is a locator function. Since it is very common to misplace one's mobile phone, the power and control device may be used to actuate wirelessly an audible sound of the mobile phone, such as its ringer, to enable the phone to be located. It is similarly common for one to misplace one's keys. Thus, the device may also include an audible device, such as a speaker, that can be wirelessly actuated using an app on the phone to emit an audible sound to enable the keys to be located. Wireless communications between the device and the phone may be via Bluetooth®, which allows the phone and device to communicate at a distance of the order of a hundred feet. Preferred implementations of the locator and other functions that may be performed by the device will be described more below.

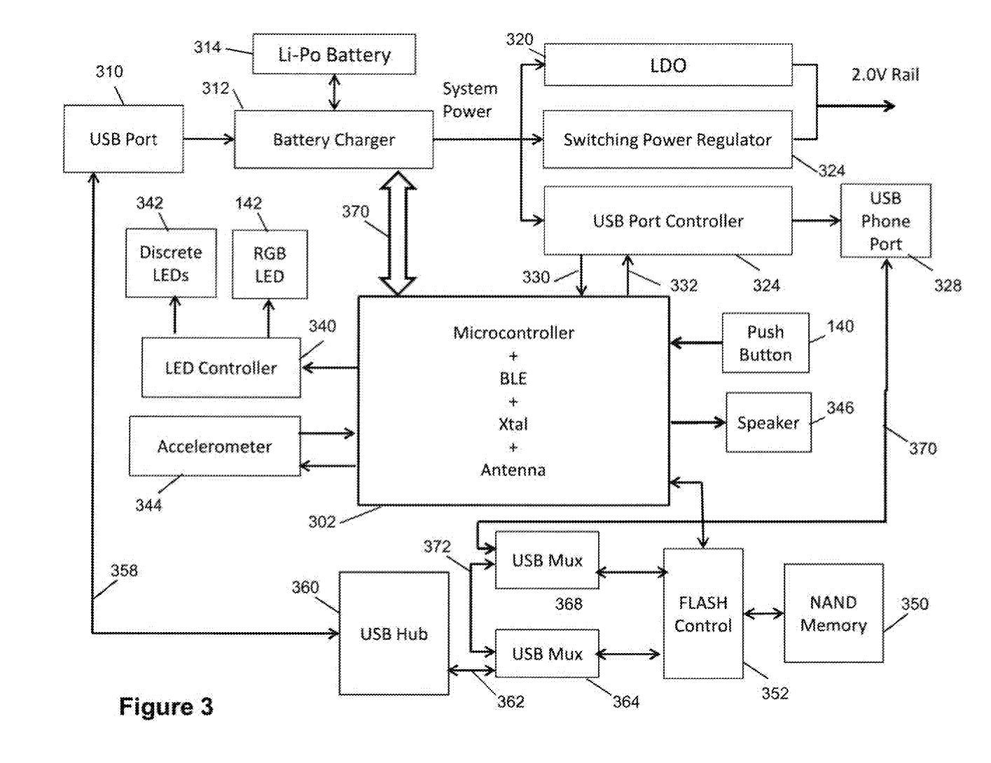

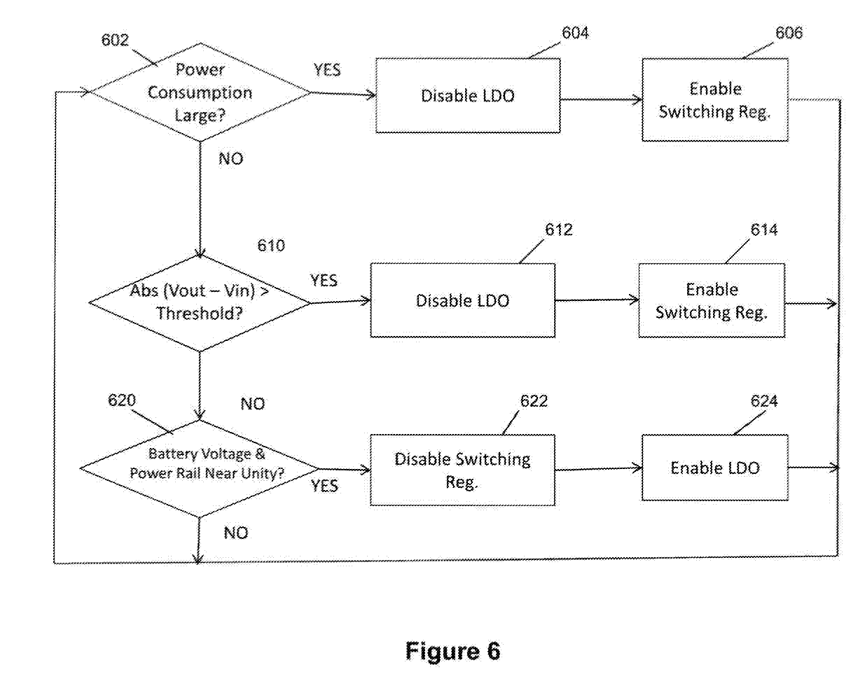

FIG. 3 is a top-level functional block diagram illustrating a preferred embodiment of the electronics within a power and control device in accordance with the invention. As shown, central to the internal electronics of the device may be a microcontroller 302 for controlling the overall operation of the device. Microcontroller 302 may be a Broadcom Corporation BCM20736 integrated circuit system-on-a chip (SoC) comprising a low power consumption, low energy integrated microprocessor and Bluetooth® wireless (BLE) circuit, a crystal controlled clock (XTAL) and an antenna. The chip also includes memory (firmware) embodying executable instructions and data for controlling the microcontroller to perform operations in accordance with the embodiment, as described herein. A USB port 310 may be connected to USB connector 122 of the device for receiving power from a USB power source, such as a computer, and for supplying the power to a battery charger 312 for charging a rechargeable battery 314. Battery 314 may be a lithium-polymer battery supplying about 400 mAh, which is sufficient to power a mobile phone for an hour or two until it can be recharged. The battery also supplies power through the battery charger 312 to a low drop out (LDO) low current regulator 322 and to a switching power regulator 322 which supply power at, e.g., 2.0V, to power the electronics of the device, and supply power to a USB port controller 324. The LDO has an efficiency which is a function of the ratio of output voltage to the battery input voltage (Vout/Vin). When the ratio is close to unity, the LDO is most efficient and it is more efficient to use the LDO to power the device, particularly at low current. The switching regulator is more efficient at higher currents and when there is a larger difference between Vout and Vin. The microcontroller may implement a process (shown in FIG. 6 and explained below) to determine which regulator to use to power the device at any particular time. Power is supplied from the battery charger 312 to the mobile phone 102 via the USB port controller 324 and a USB phone port 328 which connects to cable 104. The microcontroller 302 may monitor the USB port controller 324 via a bus line 330, and control the port controller via another bus line 332.

The device electronics may also include an LED controller 340 for controlling the RGB multicolor LED 142 on the top of the device to indicate a charging operation and the charge level of the internal battery 314, and control discrete LEDs 342 located, e.g., in or below ring 144 on the top surface of the device so as to be visible when illuminated. The discrete LEDs may be used, for instance, to indicate power flow into the device from USB port 310 for recharging the internal backup battery 314 and/or for powering the phone via the USB phone port 328. The power and control device 100 may receive external power via USB port 310 for simultaneously recharging the device internal battery 314 and for supplying power to the phone via the USB phone port 328. The device may additionally include an accelerometer 344 which detects and characterizes forces exerted on the device. The accelerometer may detect a user shaking the device to initiate a process performed by the microcontroller 302 for determining the backup battery 314 charge level (as will be described) and for activating the RGB LED 142 to indicate the charge level to the user. The accelerometer may also be used to detect other user gestures as commands for other purposes, as will be described.

The microcontroller 302 may also receive an input command from, for example, pushbutton 140 on the top of the device to perform an operation, such as the previously described phone locator operation. In response to input commands, the microcontroller 302 may activate its embedded Bluetooth® Low Energy (BLE) circuit to transmit wirelessly certain codes as predetermined combinations or sequences of tones to the phone. These tones may be received by a Bluetooth® receiver in the phone, decoded, and used to initiate prescribed actions. Different input commands to the microcontroller may comprise, for example, different numbers of actuations of the pushbutton 140 within a particular time period. The device may additionally include a speaker 346 controlled by the microcontroller to provide an audible indication to a user.

Other functions that the device 100 may perform relate to data storage, data synchronization and data communications. Accordingly, the device electronics may include non-volatile memory 350, such as NAND flash memory, and a flash memory controller 352 that are under the control of the microprocessor 302. Data may be communicated between the device memory 350 and an external computer via the USB port 310, and between the memory and the phone via the USB phone port 328. Conveniently, the flash memory may also be used to transfer data between the user's mobile phone and the user's tablet or another data source. The USB port 310 may be connected to a USB hub 360 by a bidirectional bus 358. The USB hub 360 may be connected by a bidirectional bus 362 to a first USB multiplexer (Mux) 364 which in turn is connected to the flash controller 352 and to memory 350. A second USB Mux 368 may have a bidirectional bus 370 connected to the phone USB phone port 328, and may also connected to memory 350 via the flash controller 352. USB multiplexers 364 and 368 may be likewise connected together via a bidirectional bus 372. This arrangement enables data to be communicated bidirectionally between the USB port 310 and the memory 350, and between the memory and the USB phone port 328. The two USB multiplexers 364 and 368 allow data communications to be switched between the memory and the two USB ports. The memory 350 enables the device 100 to store and transfer data between devices connected to the USB ports, and the microcontroller allows the device 100 to perform operations on the data, as for encryption and data synchronization.

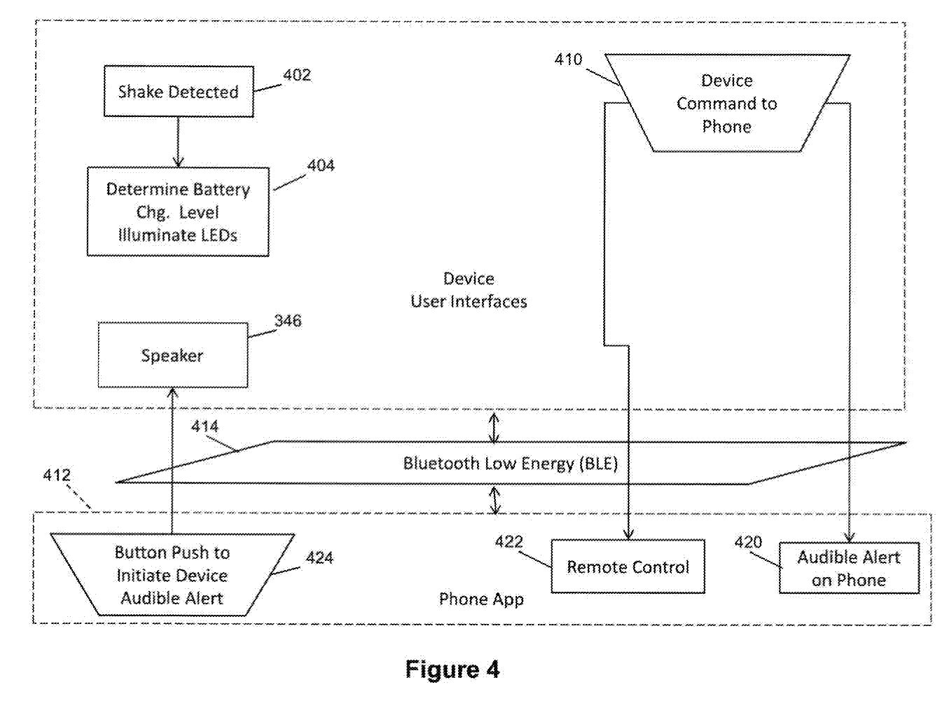

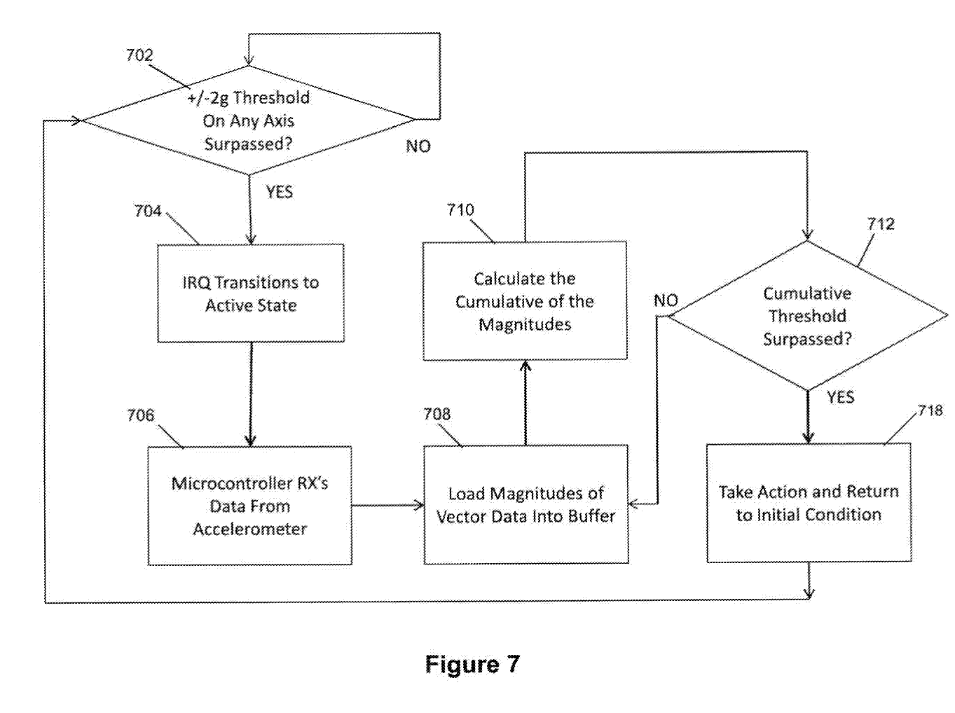

FIG. 4 illustrates user interfaces and processes in embodiments of a device and a phone app for performing operations in accordance with the invention. User interfaces in the device 100 may include a shake and gesture detector utilizing the accelerometer 344 for detecting and measuring the forces and movement exerted on the device by a user. One use of these is for checking and indicating the charge level of the internal backup battery 314. Upon the user shaking or moving the device in a gesture (such as in a predetermined direction for a certain time), the device movement will detected at 402 using the accelerometer 344 to activate a process performed by the microcontroller to decode the movement, as will be described in connection with FIG. 7, and perform an associated operation, such as determining the charge level of the device battery and indicating the charge level by illuminating one or more of the multicolor RGB LEDs 142, as shown at 404. In a preferred embodiment, when the battery charge level drops below a predetermined level, e.g., 20%, the red LED may be illuminated to indicate the user is time to recharge the internal battery. When the device is connected to and charging a mobile phone, the LEDs may illuminate orange, and when the charging is completed, the LED may illuminate green.

Another user interface on the device is pushbutton 140. The pushbutton may be activated at 410 to send commands to the mobile phone app 412 via the Bluetooth® low energy wireless link 414. The commands may cause the phone app to activate an audible alert on the phone, as shown at 424, for the previously described phone locator function. The pushbutton may also send commands to the phone app at 422 to remotely control the phone to perform various operations such as, for example, controlling the phone camera. Additionally, the commands 410 received by the phone app may also cause the phone to remotely control external devices, such as a music player. Similarly, the phone app 412 may include a pushbutton operation 424 that sends a command to the device via the Bluetooth® wireless link to activate the device speaker 346 remotely to perform the previously described keys locator function. As may be appreciated, the controllable functions that may be performed on the device and on the phone will be determined by the design of the phone app and the firmware within the device.

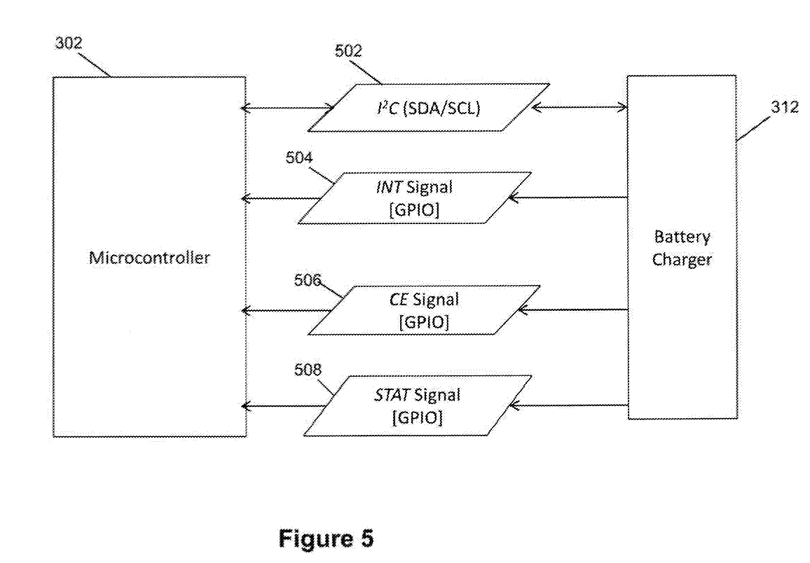

FIG. 5 illustrates the interfaces and the signals exchanged between the microcontroller 302 and the battery charger 312. The battery charger may perform several different functions. As indicated in FIG. 3, the microcontroller and the battery charger to be connected by a bus 370 over which data and control signals are exchanged. As shown in FIG. 5, the microcontroller and battery charger may be connected by an i2C PC bus 502 over which data (SDA) and clock (SCL) are exchanged. The battery charger 312 may be an integrated circuit chip that not only controls an external charge delivered to the battery from USB port 310, but also measures the battery voltage and the current being supplied to the battery from an external source, and voltage and current supplied from the battery to the USB phone port 328. For this purpose, the battery charger may include voltage and current measuring circuits and an analog-to-digital converter (ADC) to supply the measured data to the microcontroller. As will be described, this data is used not only for determining the charge level of the internal battery, but also for controlling the LDO 320, switching power regulator 322, and the USB port controller 324. The battery charger may supply an interrupt (INT) signal 504 as a general purpose I/O (GPIO) signal to the microcontroller to wake up the microcontroller, a charge enable (CE) GPIO signal 506, and a status (STAT) GPIO signal 508 to indicate the status of a charging process of the battery.

FIG. 6 illustrates a process (algorithm) performed by the microcontroller under control of its embedded firmware instructions to switch between the LBO 320 and the switching regulator 322 based upon voltage and current conditions, in order to maximize efficiency and reduce power consumption within the device. At 602, the microcontroller process may determine whether the power consumption is larger than some predetermined level. If so, it disables the LDO at 604 and enables the switching regulator at 606 so that the switching regulator, which is more efficient for large power consumption, controls the power supplied to the device electronics. If the power consumption is not determined to be larger than the predetermined level at 602, at 610 the process determines whether the absolute value of the difference between the output voltage (Vout) and the input voltage (Vin) exceeds a predetermined threshold. If so, the process disables the LDO at 612 and enables the switching regulator at 614 for efficiency reasons. As previously described, the LDO has a maximum efficiency when the ratio of the output voltage to the input voltage is approximately unity and the current is low (power consumption is low), whereas the switching regulator is more efficient at higher currents for larger differences between the output and input voltages. If the absolute value of the difference between the output and input voltages the start exceeds the predetermined threshold as determined at 610, the process proceeds to step 620, at which the process determines whether the battery voltage and the power rail voltage are approximately the same, in which case it disables switching regulator at 622 and enables the LBO at 624. Otherwise the process repeats.

FIG. 7 illustrates the process performed by the microcontroller to detect and measure the movement of the device 100 using the accelerometer 344 in order to initiate an operation. For purposes of illustration, the process for determining and indicating the battery charge of the internal backup battery by shaking the device will be described. It will be appreciated, however, that other types of movements (gestures) may be detected and used to initiate other operations.

The accelerometer 344 may be a conventional integrated device that measures the vector magnitude of the three-dimensional G forces exerted on the device by it being moved, shaken for instance. To determine and indicate the battery charge level, the user may shake the device, for example. If at 702, the G force on any axis exceeds a predetermined threshold, such as 2 G's, an interrupt (IRQ) will be sent at 704 to the microcontroller to cause it to enter an active state. At 706 the microcontroller receives the G force vector data from the accelerometer, and at 708 loads the magnitudes of the data into a buffer. At 710, the microcontroller may calculate the magnitudes of the vector data stored in the buffer, may determine the corresponding directions (e.g., up, down, right, left), and calculate the accumulated magnitudes as a function of time or duration or both. If the cumulative magnitudes surpass a predetermined threshold at 712, the microcontroller acts at 714 to determine the battery charge level using the current and voltage data provided by the battery charger. It may determine charge level using voltage and current accumulated over a predetermined period of time, and indicate the charge level using the RGB LEDs as described above. The process may then return to the initial condition at 702. The cumulative threshold at 712 may be used as a necessary pre-condition for initiating the process of determining battery charge level to conserve internal battery power. The initial and cumulative threshold conditions discriminate between an actual shaking motion by the user and a momentary G force caused, for example, by dropping the device, and the three-dimensional directional data from the accelerometer may be used to discriminate between a shaking for checking battery charge and some other gesture for initiating another operation.

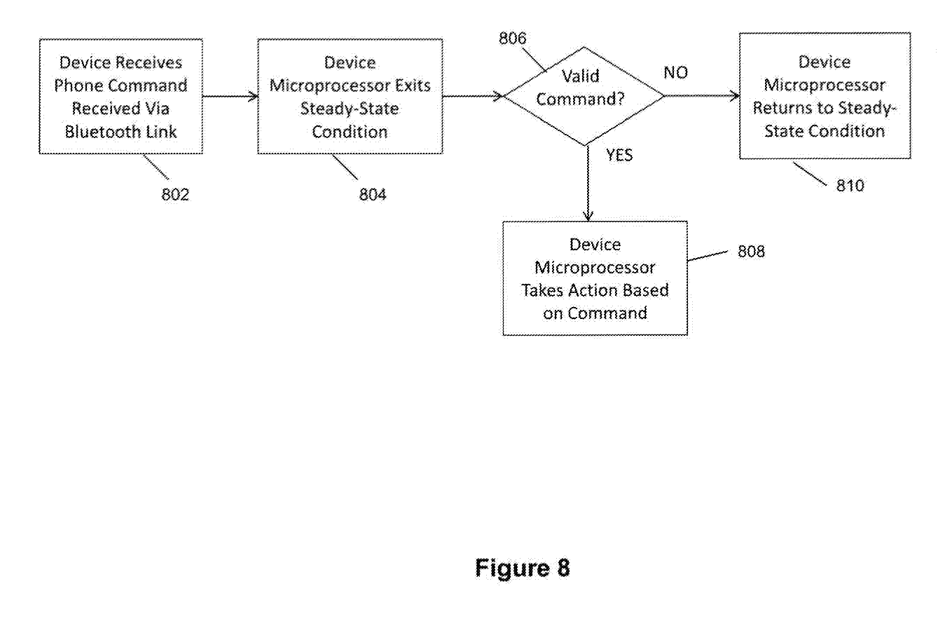

FIG. 8 illustrates a process performed by the microcontroller of the device in response to commands received from the phone. At 802, the device may receive a phone command via the Bluetooth® wireless link. At 804, the microcontroller wakes up and exits a steady-state condition. At 806, the microcontroller in the device decodes the received data and determines whether the command received from the phone is a valid command. If so, the device microcontroller takes the appropriate action at 808 based upon the command. For example, the phone command may be to initiate a locator operation on the device by causing the microcontroller to send tones to the device speaker to emit an audible sound. On the other hand, if the command is determined not to be valid at 806, the device microprocessor returns at 810 to the steady-state condition without acting upon the command.

The embodiment affords another type of device locator function other than actuating an audible device alarm. Using the phone built-in GPS function, the phone app may remember the last GPS location of the device, which is useful if the device is out of range of the BLE wireless link at the time the locator operation is initiated. This may be accomplished by instructions in the firmware in the device microcontroller causing the device to transmit a periodic “heartbeat” signal (code) via the Bluetooth® wireless link to the phone app. The heartbeat signal may be sent every sent minute or two, for example. Upon receiving the signal, the phone app may determine its current GPS location using its GPS function, and store the current location in phone memory. Each new heartbeat signal may update the GPS location stored in the phone memory. If a user misplaces his or her keys with the device attached, the phone app may read the last GPS location stored in the memory and show that location on a map on the phone display. Thus, the user may return to that location and retrieve the device and keys.

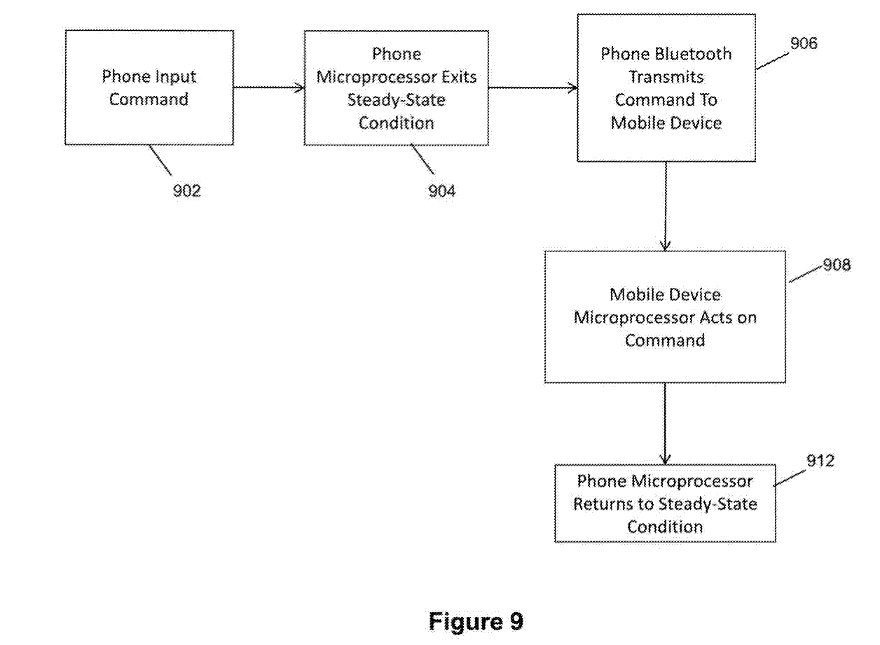

FIG. 9 illustrates a process performed by the phone microprocessor for responding to a user's input command on the phone. As shown, at 902, the phone receives an input command, which causes the phone microprocessor to exit from a steady-state condition. At 906, the phone transmits via the Bluetooth® wireless link an appropriate command to the mobile device in response to the input command received at 902. At 908, the mobile device receives, decodes and acts upon the command from the phone, and at 910 the phone microprocessor returns to a steady-state condition awaiting new input. The command may be to initiate an audible alarm on the device to enable it to be located.

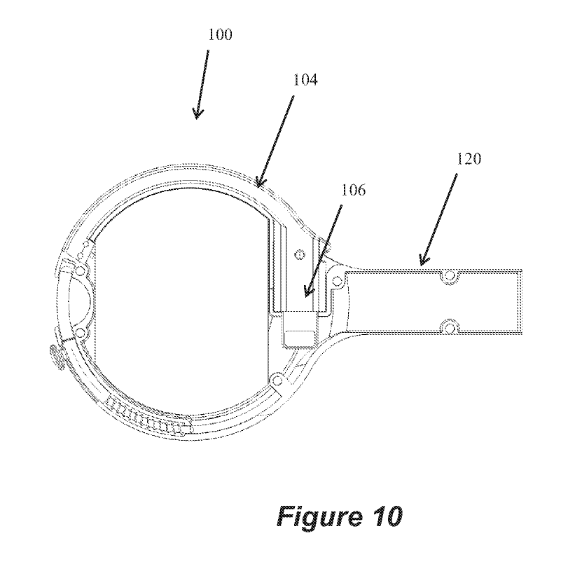

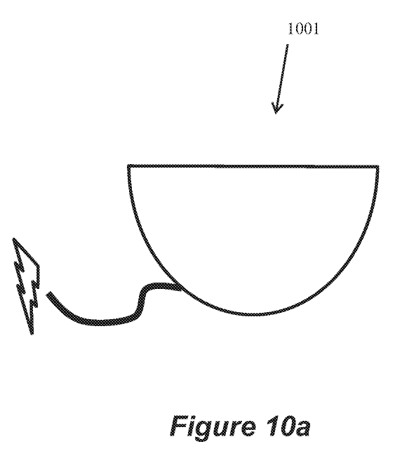

FIG. 2C shows a rechargeable backup battery which is shaped into a hexagon so that the battery can fit snugly into the device. In comparison, conventional rechargeable batteries are rectangular or square in shape, which creates too much dead space between the battery and a circular or round container. Other shapes of the battery are possible, as the more sides the battery has the nearer it gets to a round shape for fitting inside the disk. FIG. 10 shows a variation in which the battery is generally shaped like a disc but having two opposite ends truncated or pared off. The curved sides of the battery fill up the space inside the device 100. The flat sides of the battery are used to stabilise the position and orientation of the battery inside the device 100, and to allow other parts of the device such as connectors and electronic parts to be tucked into the device 100. In FIG. 10, the cable with the connector 106 is slightly different from that shown in FIG. 2C. Therefore, the battery provides the possibility of reduced dead space in the device 100 by having a non-rhombus for better fit. The connector 106 is fixed to the cable at an angle instead of extending from it, allowing the connector 106 to be inserted neatly into the device 100 such that the connector is parallel to one of the flat sides of the battery, giving a snug fit. In contrast, the orientation of the connector 106 to the cable 104 FIG. 2C is linear which may make it slightly more difficult for the edges of the connector 106 to be flushed to the outer edge of the device 100.

In another embodiment, the internal rechargeable battery is rechargeable by induction. Inductive charging is also known as “wireless charging”, and employs an electromagnetic field to transfer energy between two objects. Typically, induction charging is done with a charging station. Energy is sent through an inductive coupling between the charging station and the electrical device, which can then use that energy to charge batteries. An induction charger typically uses an induction coil (not illustrated) to create an alternating electromagnetic field from within a charging station. A second induction coil (not illustrated) within the device 100 takes power from the electromagnetic field and converts it back into electric current to charge the battery in the device 100. Theoretically, two induction coils in proximity combine to form an electrical transformer and allow energy transfer. The underlying science of this is known to the skilled man and does not need explanation here in detail. In this embodiment, therefore, the USB connector 122 on the device 100 for recharging the battery may be omitted, providing a rounded disc-shaped device. To charge the battery inside the device 100, the device 100 may simply be placed on an inductive charging station. Preferably, the inductive charging station is shaped as a container or bowl 1001 for holding key chains, as shown in FIG. 10a. Specifically, the base of bowl 1001 contains an inductive coil (not illustrated) which is able to create a magnetic field. The device 100 contains a corresponding inductive coil which cooperates with the inductive coil in the bowl 1001 to allow inductive power transfer of the electromagnetic field from the bowl 1001 to the device 100, and received power useable to charge up the battery in the device 100. Therefore, the user may simply dump the device 100 along with his keys into the bowl 1001 and collect them when they are charged up just by being inside the bowl 1001. Naturally, the bowl 1001 is wired to the power grid for a supply of power to create the induction charging. When used, the device 100 can simply be a key ring attached to a bunch of keys, to be deposited in the bowl when the user arrives home or to the office. In practice, there is no need for the user to remember specifically to recharge the device 100. The device 100 is recharged simply by being left in a place where it is supposed to be left in, and the user has the benefit of a fully charged device whenever he collects the bunch of keys as he leaves his office or home.

Various advantages are made possible by using inductive charging. For example, there is no wire required for charging up the device 100. Furthermore, as there is no need for any wire connectors for charging up the device 100, there are no or less exposed conductive parts such as a plug for plugging into a socket. It follows that there is reduced possibility of corrosion of the now enclosed inductive and battery electronics, away from water or oxygen in the atmosphere. Furthermore, without the need to constantly plug and unplug the device 100, there is significantly less physical wear and tear of the device compared to the case where a connector is required for charging the device 100.

In a variation of this particular embodiment, resonance charging or resonant inductive charging, also known as electrodynamic induction is used instead of simple inductive charging. Resonant inductive charging uses near field wireless transmission of electrical energy between two magnetically coupled coils that are part of resonant circuits tuned to resonate at the same frequency, and allows charging of the device 100 at a distance. Resonant inductive transfer works by making a coil ring with an oscillating current, which generates an oscillating magnetic field. A second coil brought near the first coil will be able to pick up most of the energy, even if the second coil is some distance away. Therefore, another advantage is that the device 100 does not need to be positioned in a specific way to the charging station in order to create an inductive coupling. Further details about resonant charging are known to the skilled man and do not need greater elaboration here.

In another embodiment, the device 100 is able to communicate wirelessly with a data storage host such as a cloud system, a computer, a mobile phone or another other suitable host. The memory inside the device 100 can be used to store data, including digital documents, files or software, by downloading the data wirelessly from the host. When needed, data can be uploaded to the same host. This also removed the need for any connector for data transfer. In a variation of the embodiment, if the device 100 is not required to function as a power charging device for a mobile phone, even the mobile phone cable 104 can be omitted.

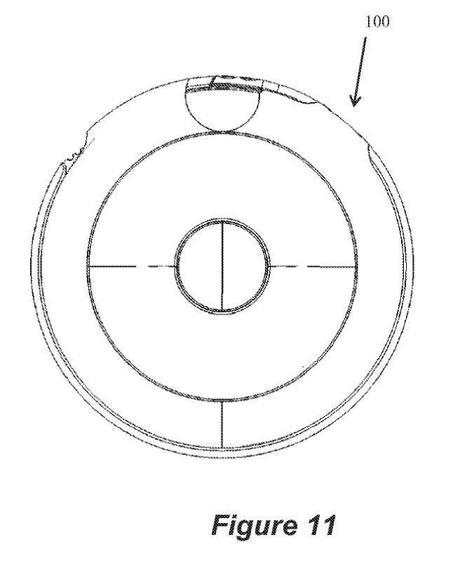

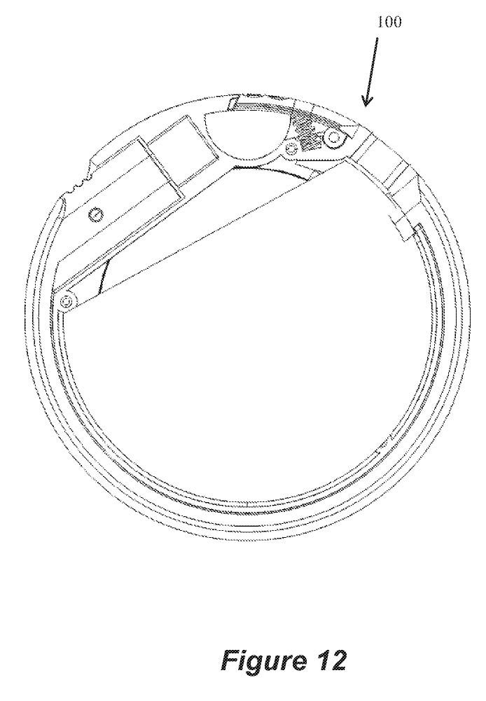

Preferably, the wireless communication protocol for data transfer between the memory inside the device and an external host may be, for example, WiFi. The wireless data transfer allows the USB connector 122 described in the afore embodiments to be omitted. This also allows the device to be shaped into a round disc-like object without the extending projection 120, as shown in FIGS. 11, 12, 13, 14, and 15. More specifically, FIG. 11 shows a plan view of a device 100 which does not have the extending projection 120. It is round in the plan view, shaped like a disc. FIG. 12 is a cross-section of the device 100 in FIG. 11. The cable 104 having a connector 106 adapted to interface with the mobile phone is shaped such that its outer edge when inserted into the device housing is flushed to the outer edge of the device housing. Generally, the positioning of the connector in the disc is reminiscent of the ouroboros to provide an agreeable aesthetic.

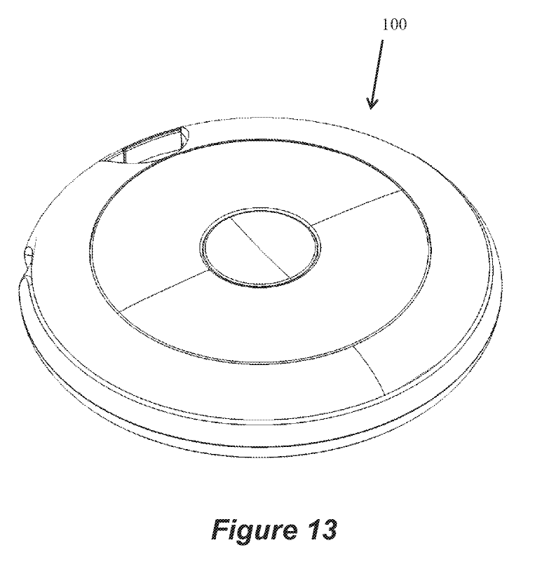

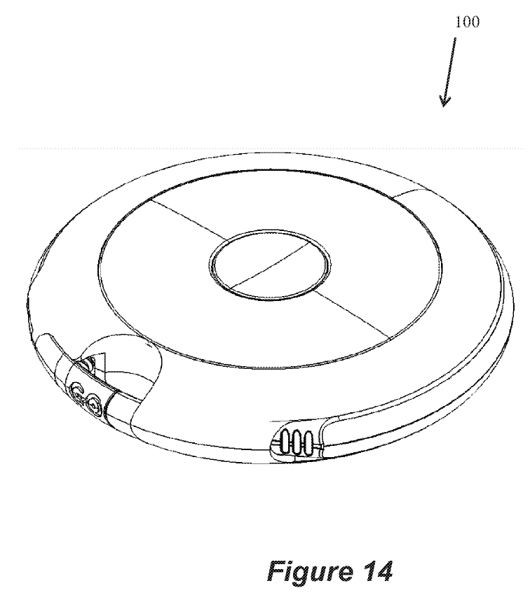

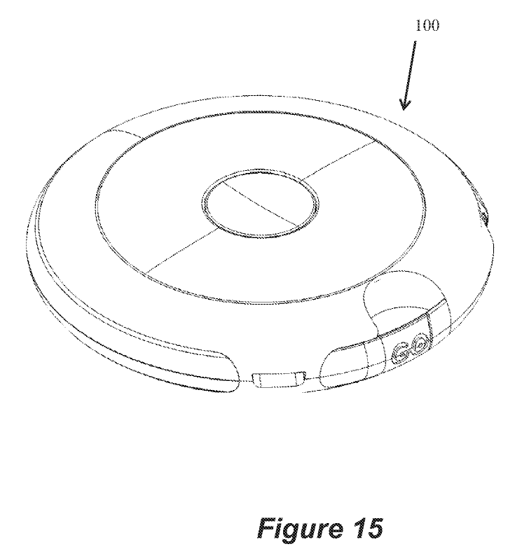

FIG. 13 shows the device 100 of FIG. 11 in the front view. FIG. 14 shows the device 100 of FIG. 11 in the back view. FIG. 15 shows the device 100 of FIG. 11 in the back view but flipped over from that in FIG. 14. The round disc shape is suitable for be carried in any container or pocket and has a smooth edge which is unlikely to be caught by any loose fabric. In use, the device 100 is configurable into a external wireless hard disk for the host. On one hand, the device can be registered with the host as an external hard disc (e.g. C drive, D drive and so on). Alternatively, the device can serve as a backup of the memory of the host instead of acting as an additional disk drive.

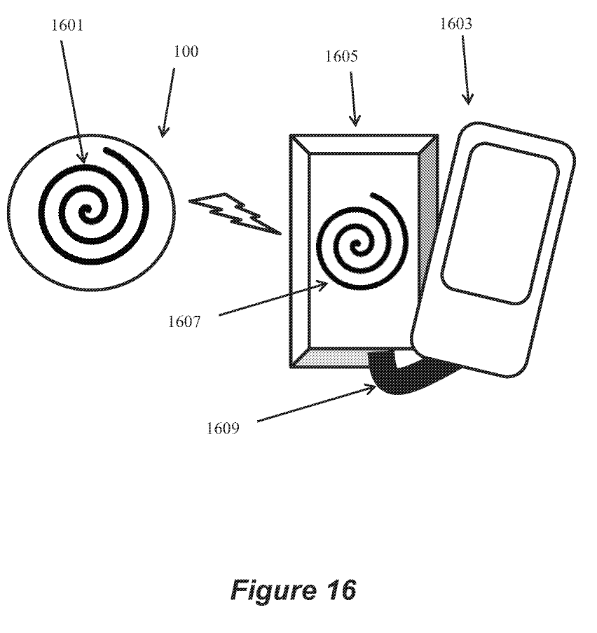

In a variation of the embodiment, the device 100 itself can also be provided with two induction coils (not illustrated). One coil is configured for coupling with another coil in the charging station for charging up the rechargeable battery in the device 100 by induction, and another coil for coupling with another coil in a mobile phone for charging up the mobile phone by induction. Optionally, as shown in FIG. 16, the mobile phone may either be in-built with a coil, or the mobile phone may be provided with a phone casing 1605 that contains a coil 1607 and the phone casing has a connector 1609 for coupling the coil in the casing 1605 to the mobile phone for recharging the battery in the mobile phone 1603. Conveniently, the user can charge up his mobile phone simply by holding the disc against the mobile phone, while applying the mobile phone at the same time to his ear to engage in a conversation.

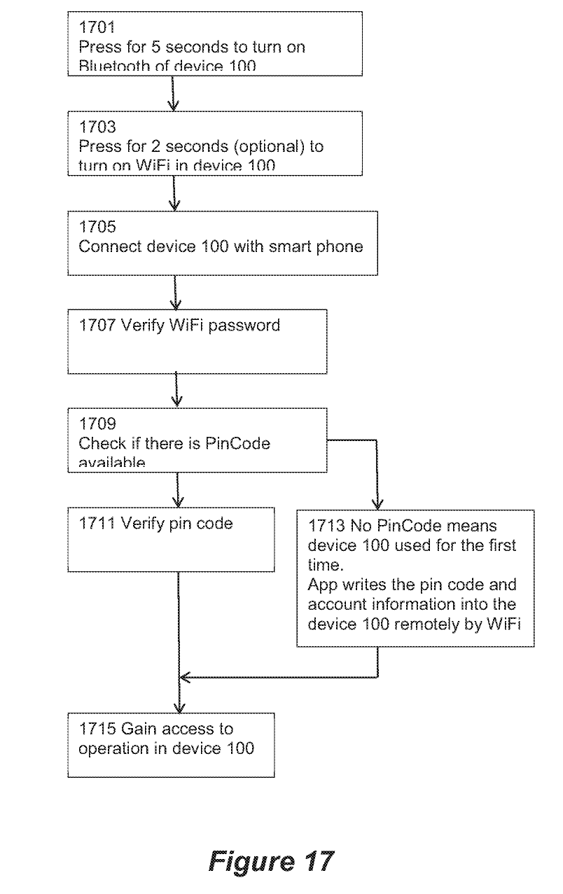

FIG. 17 shows how the device 100 communicates with a computer or a smart phone app normally and when it is first unpacked. When the device 100 is first unpacked from having been purchased and switched on the first time, the display on the device 100 is lit and emanates a blue colour. The user then initiates the device 100 by pressing on the pushbutton 140 and holding it pressed for 5 seconds, at step 1701, which causes the LED on the device 100 to turn from blue to a purple colour, indicating to the user that the device 100 is now in the initiation mode. At the same time, the Bluetooth module inside the device 100 is switched ON.

The user then presses on the device 100 again for two seconds, at step 1703, to switch on the WiFi module inside the device 100.

The user then connects his smart phone or computer to the device 100 by WiFi, at step 1705.

Subsequently, a message window pops up in the computer (or smart phone, depending on which is used) which prompts the user to download an application from the device 100 into the computer and to install the application. The user presses on a “yes” button in the pop up window, and the device transmits the application's installation file into the computer and installs the application into the computer. The user is then able to open the application for the first time by clicking on an icon on the desktop, which pops up a window prompting the user to create a user account and enter a unique 4 digit personal identity number (PIN) which will be used from then on to allow the device 100 to identify the user and to permit the computer to communicate with the device 100. All these are represented as step 1707 in FIG. 17.

Preferably, there is a further step, step 1709, of the app in the computer checking if there is a pin code stored in the device 100. The aforementioned username and password are used for WiFi communication between the device 100 and the computer (or smart phone), or between the device 100 and a cloud system. However, a pin code is used for allowing the computer to access the memory in the device 100. If the app is able to detect a recognized pin code in the device 100, the app will allow access to the memory of the device 100 by the computer. If the app cannot find a pin code in the device 100, then the app will consider that it is the first time the user is using the device 100, and the app will write a pin code into the device 100, at step 1713. Henceforth, the app will be able to access the memory in the device using the pin code for identifying the device 10.

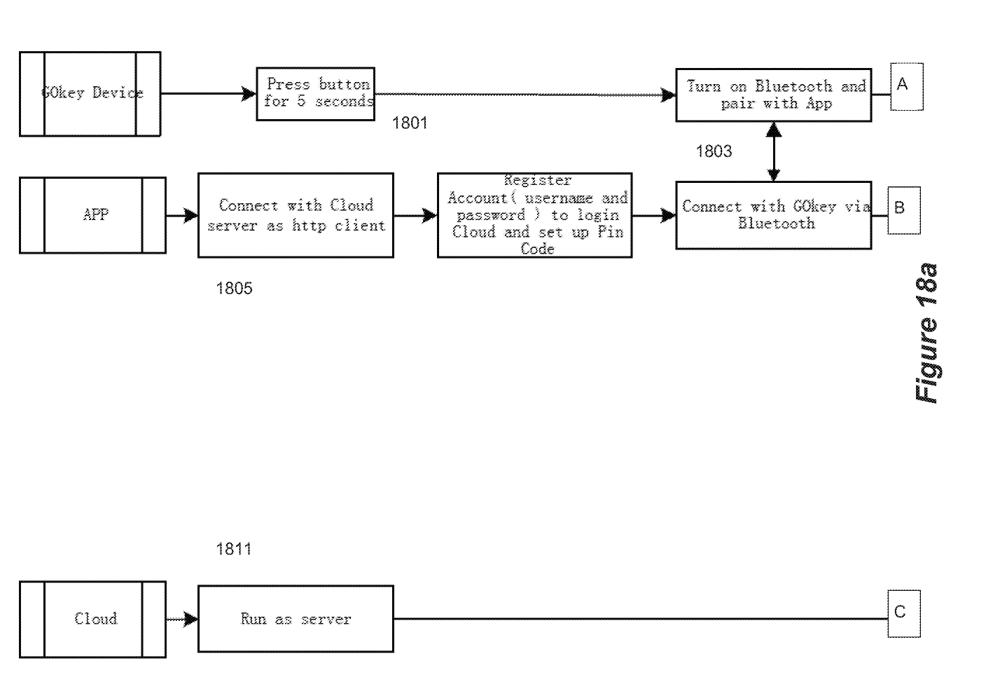

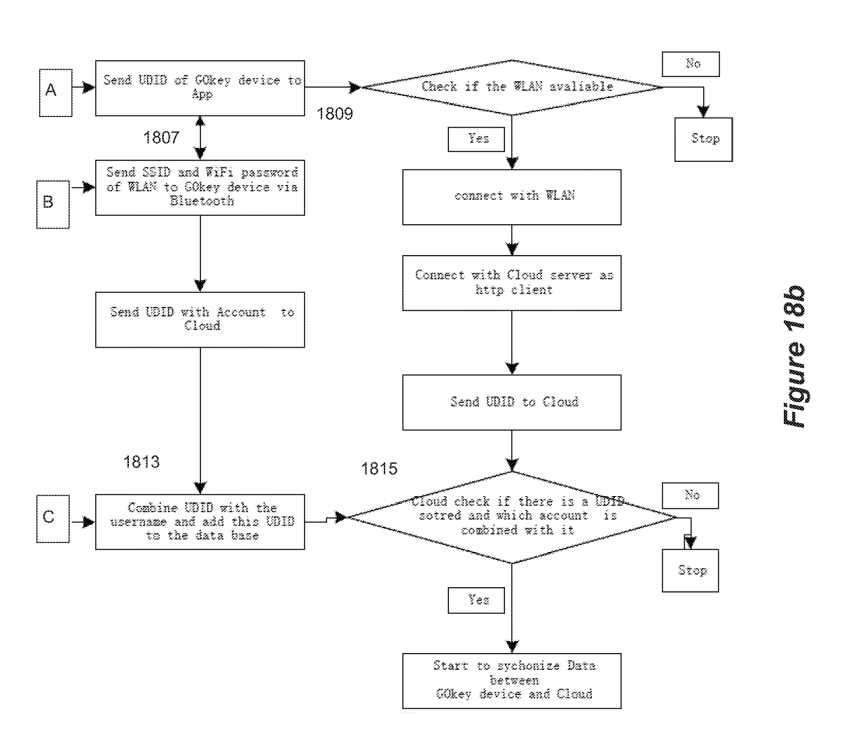

FIG. 18 is another flowchart which demonstrates how the device 100, termed the “GoKey” in the flowchart, interacts with a computer, an app in a smart phone and with a cloud system. The figure is split between two pages due to the size of the flowchart, and the continuity between the split flowchart is marked by A, B and C.

According to FIG. 18, to switch on the GoKey 100, the user presses on the pushbutton 140 on the Gokey 100 for 5 seconds, at 1801. This turns on the Bluetooth which pairs with the app in a smart phone, at 1803.

When the app is launched, at step 1805, the app communicates with a server in the cloud system as an http client, registering the user's username and password to login to the cloud system, and to set up a Pin Code. Subsequently, the app will communicate with the Gokey 100 by Bluetooth, at 1803. The app sends the SSID and WiFi password of a WLAN to the GoKey 100 by Bluetooth, at step 1807.

At this point, the identity of the GoKey known as UDID is retrieved by the app, at step 1807. The Gokey 100 will also automatically check if a WLAN is available, at step 1809. If a WLAN is available, the Gokey 100 connects with the WLAN, after which the GoKey will connect with a cloud system through the WLAN. The UDID is sent to the cloud system to identify the GoKey.

At the same time, the app will also send the UDID retrieved from the GoKey, as well as the user account, to the cloud system.

On the side of the cloud system, which is basically a remote server system 1811, the cloud system receives the UDID and the username and adds them to the database in the server in the cloud system, at step 1813.

The cloud system first checks if there is a record of the UDID in the server, at step 1815, and if so, which account is it tied to. If the UDID is tied to an account, the cloud system starts to synchronise data in the Gokey 100 with the data in the cloud system. There is no synchronization if the UDID has no record in the server in the cloud system or if the UDID is not tied to any specific account.

Typically, after establishing WiFi communication between a computer and the device 100 for the first time, the user can access the memory in the device 100 by pressing on the button on the device for 2 seconds to switch on the WiFi module in the device 100, and the computer will be able to detect that the WiFi module in the device 100 has been switched ON. When the WiFi module in the device 100 is switched ON, the application will automatically cause a window to pop up and the user can enter the username and password in response to a prompt in the window to access the device 100.

Preferably, the device 100 has both Bluetooth® and Wi-Fi capabilities. The WiFi module (not illustrated) within the device 100 is typically kept in a sleep mode or OFF mode to conserve energy and may be awaken or switched ON only by a command from the mobile phone app received by Bluetooth. When the user requests the app to access files in the device, the computer sends a Bluetooth signal to the device and tells the device to switch on its WIFI module or WIFI function in order to communicate its data. Bluetooth® may be used by the mobile phone or a computer to send a Wi-Fi username and password to the device 100 for establishing the Wi-Fi connection. Using Bluetooth® in a computer to request Wi-Fi connection with the device allows the connection to be set up completely free from user interaction to enter Wi-Fi password and username.

Preferably, whenever the user sends data into the device 100 for storage, the application is able to automatically organize all the data which the user copies into the device into four discreet data memory pools in the device, namely, Music, Pictures, Videos and Files.

In a further variation of the embodiment, the device 100 has a biometric identification module. Preferably, the biometric identification module is a fingerprint identifier provided on the pushbutton 140. In this case, only a person registered as the owner is able to activate the device 100 to communicate with the computer by Bluetooth® and then link up with the computer by Wi-Fi. The functions of detecting fingerprint, authenticating it and permitting operations are known in the art and do not need elaboration here.

In combination of the various different embodiments, a biometric authentication device 100 has been disclosed which does not need to have a physical connector to a host for both transmission and power charging. The data transmission to and from a host can be done wirelessly. Power can be recharged into the battery wirelessly by induction, also relieving the need of a USB connector 122 for recharging the battery. In some configurations, if the device is required to provide power to charge up a mobile phone, for example, only the connector to charge up the mobile phone is required, such as a mini USB wire connector or a Lightning connector. In alternative configurations, where the device 100 is able to charge up a mobile phone also by induction or any other wireless methods, the mini USB wire connector or the Lightning connector may also be omitted. This allows the device to be fabricated with a closed casing, and without any connector or aperture which may be damaged. This prevents infusion of water, moisture, dust and particles into the device 100.

While the foregoing has been with reference to particular embodiments of the invention, it will be appreciated that changes to these embodiments may be made without departing from the invention, the scope of which is determined by the appended claims.

1. A portable mobile phone power and control device comprising:
a housing having a rechargeable battery therein;
a first connector for connection to a power source for recharging said rechargeable battery within the housing;
a second connector for supplying power from said rechargeable battery to a drained internal battery of the mobile phone, the second connector being on a cable that is stored by the housing when the second connector is not connected to the mobile phone; and
a user operable sliding latch within the housing for releasably capturing a key ring of the user within a cutout formed in the housing to attach the device to said key ring, wherein said cutout is located in an external surface of the housing and has a semi-spherical configuration, and said sliding latch is movable within an internal slot within the housing and biased by a spring to close an opening of said cutout to capture the key ring therein, and wherein said housing has a slot located in an external surface thereof, and said cable and second connector are retained in said slot for storage.

2. (canceled)

3. (canceled)

4. (canceled)

5. The device of claim 1 further comprising electronic circuitry within said housing, said electronic circuitry comprising a battery charger for controlling the recharging of said rechargeable battery, and a microcontroller having executable instructions contained within firmware for controlling the operation of the microcontroller, said microcontroller being operable to determine a charge level of said in rechargeable battery, and for indicating the charge level by an indicator on said housing.

6. The device of claim 5, wherein said electronics circuitry comprises an accelerometer for measuring and characterizing a force exerted on the device by movement caused by a user's gesture, and for actuating said microcontroller in response to a predetermined gesture to determine and indicate said charge level, wherein said predetermined gesture comprises a shaking of the device by the user.

7. (canceled)

8. The device of claim 6, wherein said accelerometer and microprocessor determine magnitudes and directions of forces on the device in three dimensions, and interpret different force characteristics as corresponding to different commands.

9. The device of claim 5, wherein said electronic circuitry further comprises a low drop out regulator for supplying power to said electronics circuitry at low current, and a switching regulator for supplying power at high current.

10. The device of claim 5, wherein said electronics circuitry further comprises a wireless communicator for communicating commands between said device and said mobile phone to perform predetermined operations.

11. The device of claim 10, wherein said commands comprise a first command sent in response to actuation by a user of an actuator on the device to cause said mobile phone to emit an audible signal to indicate a location of the mobile phone.

12. The device of claim 11, wherein said mobile phone has an application responsive to a periodic heartbeat signal sent by the device to cause the mobile phone to update and store its current GPS location, and the application is responsive to a user input command to indicate said stored GPS location on a map on a display of said mobile phone to indicate a last location of the device.

13. The device of claim 1 further comprising non-volatile flash memory within the housing for storing and transferring data between said mobile phone and another data source.

14. A portable mobile phone power and control device comprising:
a housing having a user operable latch for releasably attaching the housing to a key ring of a user;
a rechargeable battery within the housing for supplying power to a mobile phone having a drained battery; and
electronic circuitry within the housing powered by the rechargeable battery; the electronic circuitry comprising a battery charger for controlling the recharging of the rechargeable battery from an external power source and for measuring the voltage of and current from the rechargeable battery; and an accelerometer for measuring forces exerted on the device due to user movements and for providing corresponding signals to a microcontroller; the microcontroller having embedded executable instructions for controlling the microprocessor to detect shaking of the device from said signals, to determine in response to said shaking a charge level of the rechargeable battery using said voltage and current measured by said battery charger, and to control an indicator on the housing to indicate the charge level to the user, wherein said electronic circuitry further comprises a wireless communicator for communicating commands between said device and said mobile phone, and a user controlled actuator on said housing for causing said wireless communicator to send a locator command to said mobile phone to emit an audible sound from said mobile phone to indicate a location thereof, wherein said microcontroller is responsive to another locator command received from the mobile phone for causing said device to emit an audible sound to indicate the location of the device, said device further comprising flash memory within the device for storing data received from one of a first data source or the mobile phone and for transferring said stored data to a data recipient connected to said device.

15. (canceled)

16. (canceled)

17. (canceled)

18. (canceled)

19. A portable mobile phone power device comprising:
a housing having a rechargeable battery therein,
the housing comprising a first wire coil for receiving power by induction for recharging the rechargeable battery;
the housing comprising a second wire coil for transmitting power by induction for recharging a mobile phone, wherein the induction method used is resonant induction.

20. (canceled)

21. A portable mobile phone power device of claim 20 claim 19, further comprising:
a memory for data storage; and
a Wi-Fi transceiver for transmitting to and receiving data from a host device wirelessly.

22. A portable mobile phone power device of claim 21, wherein
the Wi-Fi transceiver is useable to receive data from a host device, and to re-transmit the data to a cloud server for storage; and
the Wi-Fi transceiver is useable to retrieve data from the cloud server and to re-transmit data to the host device.

23. A portable mobile phone power device of claim 21, further comprising a
Bluetooth® module; wherein
the Bluetooth® module is useable to receive a transmission from a mobile phone commanding the device to switch ON or OFF the Wi-Fi transceiver.

24. A portable mobile phone power device of claim 23, wherein
the Bluetooth® module is useable to receive from a host device a username and password for establishing communication between the portable mobile phone power and control device and the host device.
